(19) United States
(12) Patent Application Publication
(10) Pub. No.: US 2006/0150420 A1
(43) Pub. Date: Jul. 13, 2006

(54) Shaving apparatus

(76) Inventors: Anke Gerda Sinnema, Drachten (NL); Albertus Johannes Cornelis Van Der Borst, Drachten (NL); Martin Leonard Bakker, Drachten (NL); Geert-Jan Darwinkel, Drachten (NL)

Correspondence Address: PHILIPS INTELLECTUAL PROPERTY & STANDARDS, P.O. BOX 3001, BRIARCLIFF MANOR, NY, 10510, US

(21) Appl. No.: 10/559,360

(22) PCT Filed: May 28, 2004
(86) PCT No.: PCT/IB04/50806

§ 371 Date: Dec. 6, 2005

(30) Foreign Application Priority Data
Jun. 10, 2003 (EP) 03101674.4

(51) Int. Cl. B26B 19/14

(52) U.S. Cl. 30/43.6

(57) ABSTRACT

Shaving apparatus having a skin contact surface (9,15,16) accommodating at least one cutting unit (3) comprising an external stationary cutting member (4) and a matching internal cutting member (6) and a device (18-20) for providing a shaving aid to said skin contact surface (9,15,16), wherein shaving aid retaining means (35,48) are provided on at least part of said skin contact surface (9,15,16).

The invention relates to a shaving apparatus having a skin contact surface accommodating at least one cutting unit comprising an external cutting member and a matching internal cutting member, and a device for providing a shaving aid to said skin contact surface.

Such a shaving apparatus is known for example, from WO 98/08660. This known shaving apparatus (or shaver) has three cutting units or shaving heads, which are provided in the skin contact surface. Each shaving head comprises an annular region provided with hair-trapping apertures, and an internal cutting member rotating during operation and having a number of knives for cutting hair protruding through the hair-trapping apertures. The skin contact surface in use contacts and supports the skin of the user during shaving and therefore also is called a skin support surface or skin support region. The skin contact surface surrounds the annular regions of the shaving heads and further comprises the region(s) enclosed by the annular region(s) of the shaving head(s).

A shaving apparatus of the above type typically comprises a holder for an additive or shaving aid like a shaving liquid, as well as means for supplying a certain amount of additive to the skin contact surface during shaving. Generally a push button will be provided which may be operated by the user of the shaver whenever he desires to obtain or increase a gliding effect provided by the additive.

A problem of the known shavers is that the shaving aid supplied to the skin contact surface has a tendency to flow into the shaving head(s) because of suction forces caused by the rotating internal cutting member(s).

For obvious reasons the size of a holder for shaving aid cannot be very large. Thus in order to obtain a suitable period of use between the moment the shaving aid holder is filled and the moment the holder must be refilled or, if the holder is (part of) a replaceable cartridge, to obtain a suitable period of use of such a cartridge, it is desired that the shaving aid be used as effectively as possible. Of course an optimum effective use of such a shaving aid is not possible if the shaving aid supplied to the skin contact surface of a shaver is rapidly drained away through the hair trapping apertures of the shaving head(s). Moreover, if it only takes a short time before the shaving aid is drawn away from the skin contact surface through the hair trapping apertures a certain risk exists that the shaving head will run dry and a user with a sensitive skin will damage his skin. Obviously this is undesirable.

In view of the above it is an object of the present invention to provide a shaving apparatus providing an improved effectiveness of the shaving liquid and/or other additive supplied to the skin contact surface of the shaving apparatus.

To this end, a shaving apparatus of the type indicated above is characterized by shaving aid retaining means provided on at least part of the skin contact surface.

The invention will now be described in more detail, by way of example, with reference to the drawing.

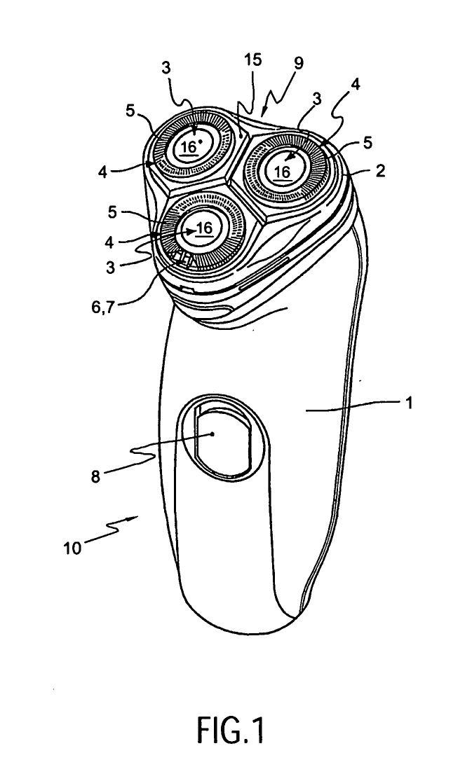

FIG. 1 shows an example of a prior art shaving apparatus having three shaving heads;

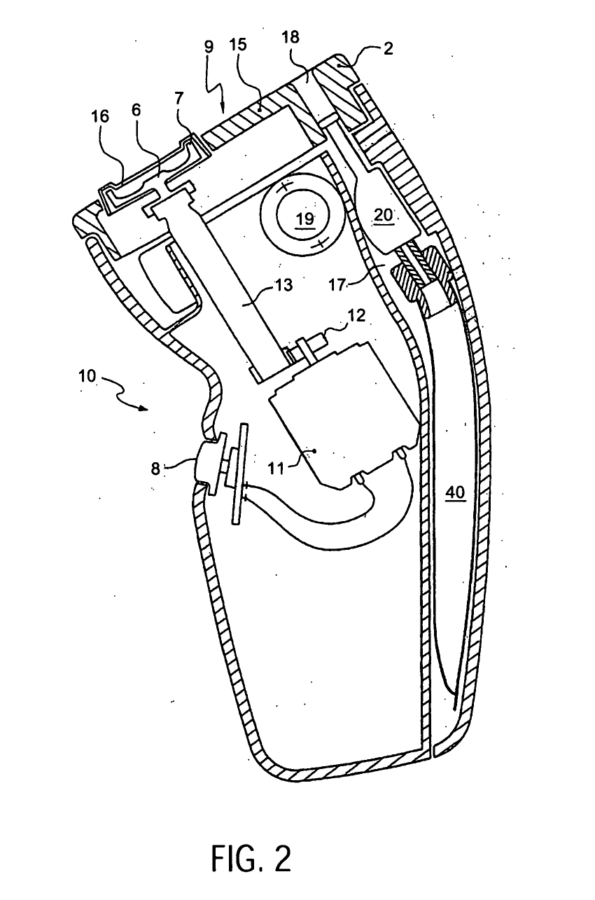

FIG. 2 diagrammatically shows, partly in cross-section a shaving apparatus similar to the apparatus of FIG. 1 and in particular shows means for supplying additive to the skin contact surface;

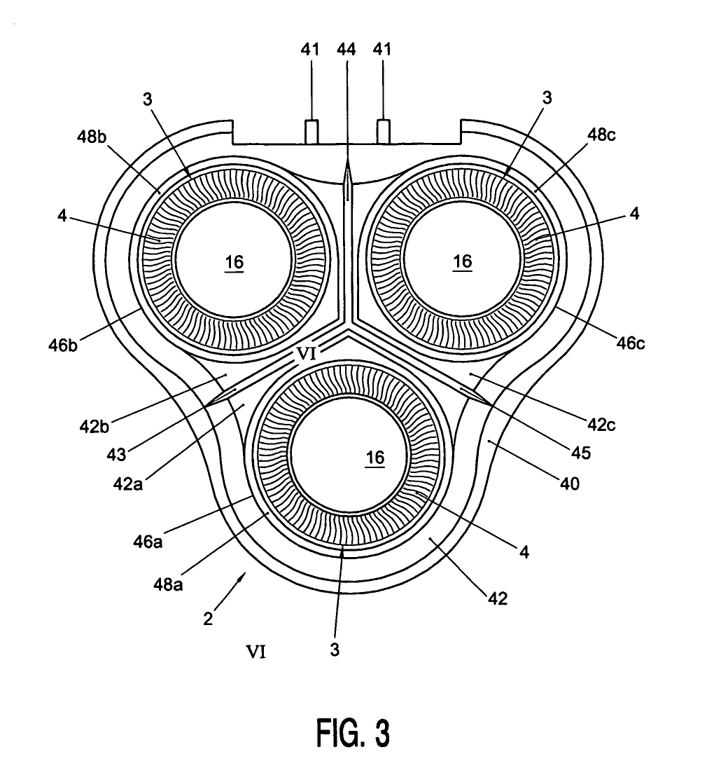

FIG. 3 is a diagrammatic plan view of an example of a shaving head holder for a shaving apparatus of the present invention;

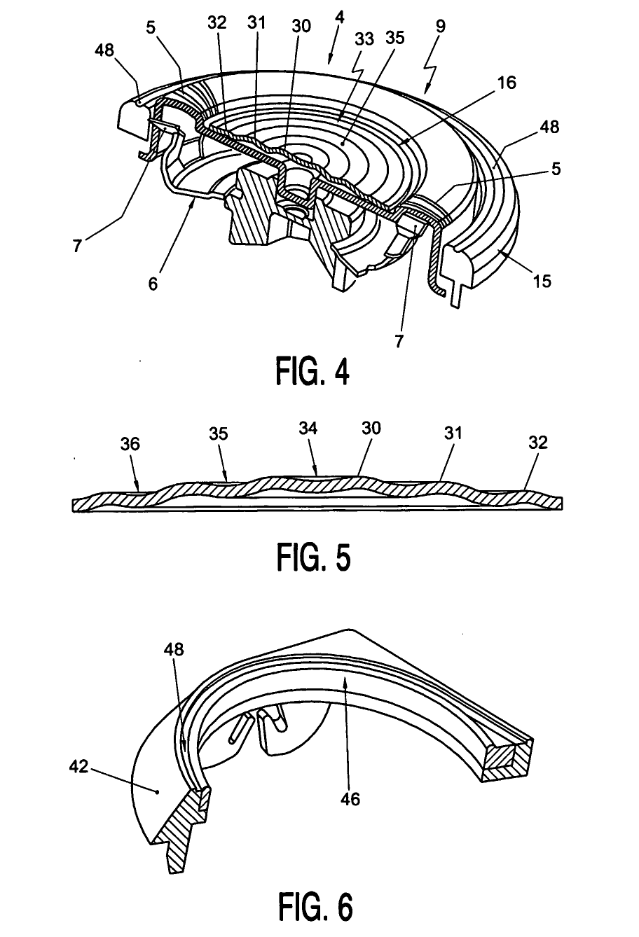

FIG. 4 diagrammatically shows, partly in cross-section, an embodiment of a shaving head of a shaving apparatus in accordance with the invention;

FIG. 5 diagrammatically shows a detail of FIG. 3 in cross-section;

FIG. 6 is a diagrammatic perspective view partly in cross-section, taken on the line VI-VI in FIG. 3 of a ring-shaped element surrounding a shaving head in accordance with the invention;

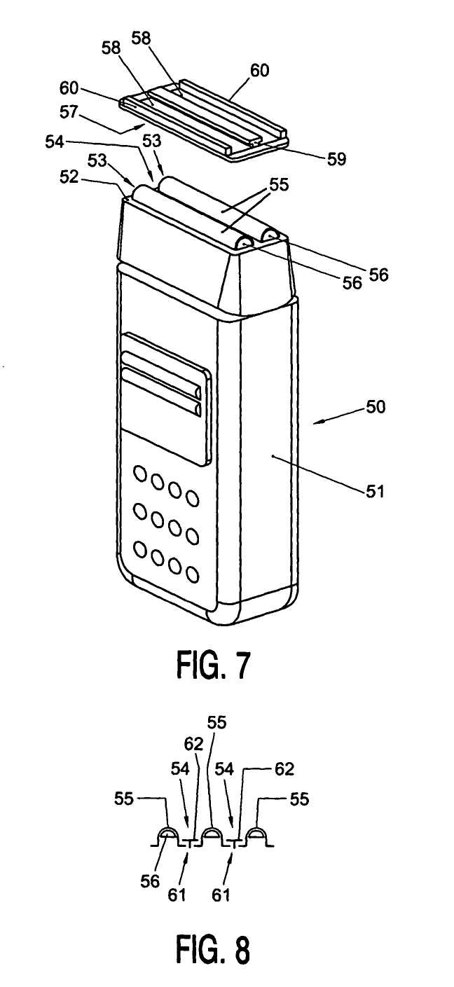

FIG. 7 diagrammatically shows another type of shaving apparatus in which the invention may be embodied; and

FIG. 8 diagrammatically shows a detail of an embodiment of a shaving apparatus of the vibrating type.

FIG. 1 shows a prior art shaving apparatus to which the invention may be applied, and FIG. 2 shows a similar shaving apparatus.

The shown apparatus 10 has a housing 1 and a shaving head holder 2, which holder can be detached from the housing and/or is hinged to the housing. Three shaving heads or cutting units 3 are present in the shaving head holder, each comprising a stationary external cutting member 4 provided with hair trapping apertures 5 and an internal cutting member 6 with cutters 7 which can be driven into rotation with respect to the external cutting member. An on/off switch 8 is also provided.

As shown in FIG. 2, the internal cutting member 6 is driven by a motor 11, through suitable transmission means 12,13.

The shaving head holder 2 has a skin contact surface 9 comprising a first skin contact region 15 surrounding the shaving head(s) 3 and a second skin contact region 16 enclosed by the stationary annular cutting member of each shaving head.

The shaver 10 has a space 17 for accommodating a holder 40 for shaving aid. The space 17 in this example further accommodates a pump 20 for pumping shaving aid from the holder to an outlet opening 18 in or near the skin contact surface of the shaver. A switch, in this case a push-button switch 19, has been provided for operating the pump 20. Further details of the shaver 10, in particular the holder and the pump, may be found in WO 98/08660.

FIG. 3 is a plan view of an example of a shaving head holder 2 for a shaver in accordance with the present invention. The shaving head holder is similar to the shaving head holder shown in FIG. 1 and has three cutting units 3. In FIG. 3 the same reference numerals as in the other Figs. have been used for similar parts. The holder has a hard shell 40 provided with hinge elements 41 for mounting the shaving head holder on the housing of a shaver. The shaving head holder accommodates a skin support member 42, which in turn accommodates the three cutting units 3. The skin support member has three sections 42a, 42b and 42c which are connected to each other by pivot lines 43, 44, 45 allowing a pivoting movement of the cutting units with respect to each other. Thereby the shaving heads may adapt to the local shape of the face of the user. Each section 42a, 42b, 42c has a kind of socket like an eye socket, accommodating a having head.

FIG. 4 is a diagrammatic view of an example of a shaving head or cutting unit 3, partly in cross-section, in accordance with the present invention. The shaving head as shown is generally similar to the shaving heads of the prior art shavers. Various parts of the shaving head of FIG. 4 have been given reference numbers corresponding to the reference numbers used in the other Figs. for similar parts.

The shaving head of FIG. 4 differs from shaving heads of prior art shavers in that shaving aid retaining means have been provided in the skin contact region 16 within the annular cutting member 4. The shaving aid retaining means in this example comprise a number of concentric ridges 30, 31, 32. In this example the concentric ridges are part of a profiled decorative cap 33 which is placed on a flat portion 34 of the shaving head within the annular cutting member 4. If so desired the portion 34 itself may be provided with a profiled surface. The decorative cap 33 is shown in cross-section on a somewhat larger scale in FIG. 5.

The profiled decorative cap in this embodiment has a generally slightly domed shape and has three circular concentric, gently sloping ridges 30, 31, 32. Any shaving aid present on the decorative cap, i.e. between the decorative cap and the skin of the user, will to a certain extent be retained in the grooves 34, 35, 36 between the ridges and will be prevented from flowing straight to the hair trapping apertures 5. In fact, the grooves 34, 35, 36 function as temporary storage zones for shaving aid. The time it takes on average for a certain quantity of shaving aid on the decorative cap to completely flow away through the hair trapping apertures will be notably longer if a profiled decoration cap is used instead of a prior art flat cover.

Though the shaving aid retaining means described above and shown in FIGS. 4 and 5 do comprise a number of circular concentric ridges, it will be understood that any type of profile which prevents additive from flowing straight and unimpeded to the hair trapping apertures may be used. For example, a star-shaped flower-shaped, or spiral-shaped pattern of ridges, or a pattern of dimples as on a golf ball or similar surface patterns may be used. Furthermore, the decoration cap may have a low friction surface.

Shaving aid will also be present in the skin contact region 15 on the skin support member 42 surrounding the shaving head(s) during operation of the shaving apparatus. Such shaving aid will also be sucked into the hair trapping apertures. In order to prevent this from happening shaving aid retaining means may be provided around the shaving head(s). In accordance with an embodiment of the invention, at least one groove surrounds each annular cutting member. An example of such a groove is shown at 48 in FIG. 4. Such a groove will prevent shaving aid present in the skin contact region 15 surrounding the shaving head(s) of a shaver from being sucked straight into the shaving head.

In accordance with a further elaboration of the idea of providing a shaving aid retaining groove in the skin contact surface surrounding an annular cutting member, a separate ring-shaped element 46 is provided around each socket for a shaving head. Such a ring-shaped element will be mounted in the skin support member around each annular cutting member and will form a low ridge preventing shaving aid from flowing straight from the skin contact region 15 into the hair trapping apertures of a shaving head.

Such ring-shaped elements 46 may be made from a suitable synthetic material or metal. The ring may be (partly) embedded into the material of the skin support member. During shaving, the top of the ring may be somewhat higher than the surrounding surface of the skin support member region, or the top of the ring may substantially be flush with the skin contact region, if a small groove is formed at the connecting faces of the shaving head holder and the ring. Such a groove may result from a somewhat lower shoulder of the shaving head holder and or the ring, or from differences in shape of mutually facing connecting surfaces of the shaving head holder and the ring near the skin contact surface.

Ring-shaped elements as well as a groove surrounding each element have been shown in FIG. 3 at 46a, 46b, 46c and 48a, 48b, 48c, respectively.

An example of a part of a shaving head holder provided with a separate ring-shaped element 46 is schematically shown in FIG. 6. FIG. 6 is a perspective view, partly in cross section taken on the line VI-VI in FIG. 3. FIG. 6 shows part of a section of a skin support member 42 and a corresponding part of a separate ring-shaped element 46 mounted in said skin support member. A groove 48 is provided at least partly along the junction of the ring-shaped element 46 and the skin support member 42 retaining shaving aid present on the skin support member and for preventing such additive from being sucked straight into the hair trapping apertures of the shaving head. The ring-shaped element may be circular, but in the embodiment shown a small triangular section is part of the ring-shaped element. Said triangular section is located at the center of the shaving head holder near the Y-shaped junction of the three pivot lines 43, 44, 45, The groove 48 may either extend along the outer contour of the triangular section or may follow the contour of the annular cutting element, or both.

Preferably, the ring-shaped element 46, or at least the top of said ring-shaped element has a low friction surface, as may be obtained, for example, by high-gloss polishing in order to enhance the gliding performance during shaving.

Of course it would be possible to provide two or even more concentric grooves in and/or around the ring-shaped elements.

It is observed that a shaving aid additive as referred to in this description may be a liquid or any other type of material suitable for the intended purpose such as, for example, a gel, a foam, a cream, a water-soluble hard material etc. . . .

In the above description, the invention has been explained with reference to a shaver having one or more cutting units of the rotary type. However, the invention does apply to other types of electric shavers like shavers having one or more cutting units of a vibrating type. Such cutting units generally have a bank of parallel cutter elements which in use vibrate below a perforated foil. The area around and, if applicable, between such vibrating cutters may be provided with shaving aid retaining means in accordance with the present invention. An example of such a shaver is disclosed in WO 02/051598 and is shown in FIG. 7. FIG. 7 diagrammatically shows an electric shaver 50 having a housing 51, a skin contact surface 52, and two cutting units 53 having outer cutting members 55 in the form of shaving foils and inner cutting members 56 cooperating with said foils. The skin contact surface 52 may be provided with one or more ridges and/or grooves along the tunnel-shaped shaving foils 53. Such ridges and/or grooves may be similar to the ridges and/or grooves disclosed above for the skin support member surrounding the annular cutting members. In the case of tunnel-shaped shaving foils, however, the ridges and/or grooves may just extend along the long side of the foil(s). Of course it would be possible to have such ridges and/or grooves surround the tunnel-shaped foil(s). Instead of elongate ridges and/or grooves, furthermore, a suitable pattern of dimples (golf ball pattern) or the like may be used.

For a shaver having two or more vibrating cutting units it would be possible to use foils covering a cutting unit as well as at least part of the intermediate area 54 between two adjacent cutting units. Such foils would leave a slit or strip-shaped area 61 between their adjacent edges, as is diagrammatically shown in FIG. 8. It would even be possible to use a single foil suitably-shaped to match at least two elongate cutting member sections for covering at least two adjacent internal cutting members as well as the intermediate area 54 between said cutting members. The foil(s) need not be perforated in said intermediate area and may be provided with longitudinal ridges and/or grooves or dimples or the like having a shaving aid retaining effect. As the foils are often rather vulnerable, however, it is possible to provide the strip-shaped area(s) 61 with shaving aid retaining means, possibly in combination with shaving aid retaining means on the foil(s) in the flat area(s) adjacent the cutting units. Such shaving aid retaining means in the strip-shaped area(s) may be provided on strip-shaped elements, which may be replaceable or not, covering at least the strip-shaped area(s), as is shown at 62 in FIG. 8.

As an alternative it is possible to use a frame 57, for example made of synthetic resin as shown in FIG. 7, above the foils 53. Said frame has a recess 58 for each cutting member, which recess has a shape narrowly fitted around the cutting member(s). In the example shown in FIG. 7, the frame is designed for two cutting members and has two outer sections 60 extending along the outer edges of the cutting members and one central section 59 extending between the cutting members. The sections 59 and 60 have shaving aid retaining means as disclosed above. It is obviously possible to use a separate frame for each separate cutting member. The frame or frames may have a low-friction surface.

1. Shaving apparatus having a skin contact surface (9;52) accommodating at least one cutting unit (3;53) that comprises an external cutting member (4;55), a matching internal cutting member (6;56), and a device (18-20) for providing a shaving aid to said skin contact surface (9;52), characterized by shaving aid retaining means (34-36;48) provided on at least part of said skin contact surface.

2. Shaving apparatus as claimed in claim 1, wherein said at least one cutting unit (3) is of the rotary type comprising an external annular cutting member (4), and wherein first shaving aid retaining means (33) are provided on the skin contact surface (9) enclosed by the external cutting member (4) of the at least one cutting unit (3).

3. Shaving apparatus as claimed in claim 2, wherein the first shaving aid retaining means comprise at least one ridge (30-32) extending around the center of the skin contact surface (9) enclosed by the annular cutting member (4) of the at least one cutting unit (3).

4. Shaving apparatus as claimed in claim 3, wherein said at least one ridge comprises at least one of the following configurations:
a) a number of concentric ridges,
b) at least one spiral-shaped ridge,
c) at least one star-shaped ridge,
d) at least one flower-shaped ridge.

5. Shaving apparatus as claimed in claim 2, wherein the first shaving aid retaining means include a pattern of dimples in at least part of the skin contact surface.

6. Shaving apparatus as claimed in any one of the claims 2 to 5, wherein the skin contact surface (9) provided with said first shaving aid means is the surface of a decorative cap (33).

7. Shaving apparatus as claimed in claim 6, wherein the decorative cap has a generally domed shape.

8. Shaving apparatus as claimed in claim 6 or 7, wherein the decorative cap has a low friction surface.

9. Shaving apparatus as claimed in any one of the claims 2 to 8, wherein second shaving aid retaining means are provided on the skin contact surface (9) surrounding the at least one cutting unit.

10. Shaving apparatus as claimed in claim 9, wherein the second shaving aid retaining means comprise at least one groove (48) surrounding the external stationary annular cutting member (4) of the at least one cutting unit (3).

11. Shaving apparatus as claimed in claim 9 or 10, wherein the skin contact surface is the surface (9) of a skin support member (42) having a socket for each cutting unit (3), and wherein a ring-shaped element (46) is placed in each of said sockets and encloses a corresponding cutting unit (3), a shaving aid retaining groove (48) being at least partly provided at the junction of said ring-shaped element (46) and the surrounding skin support member (42).

12. Shaving apparatus as claimed in claim 11, wherein at least the top surface of each ring-shaped element (46) surrounding a cutting unit (3) is a low-friction surface.

13. Cutting unit of the rotary type for a shaving apparatus as claimed in any one of the claims 2 to 12, said cutting unit having an external annular cutting member (4) and a skin contact surface (16) enclosed by the external cutting member (4), wherein said enclosed skin contact surface (16) is provided with shaving aid retaining means (34-36).

14. Shaving apparatus as claimed in claim 1, wherein said at least one cutting unit is an elongate cutting unit (53) of the vibrating type having a perforated foil (55) as an external cutting member, and wherein shaving aid retaining means are provided along at least one of the sides of the at least one cutting unit (53).

15. Shaving apparatus as claimed in claim 14, wherein said at least one of the sides comprises at least one long side of at least one cutting unit (53).

16. Shaving apparatus as claimed in claim 14, wherein a frame (57) is provided having a recess (58) for each cutting unit (53) and having frame sections (59,60) extending along the cutting units, said frame sections at least partly forming skin contact surfaces provided with shaving aid retaining means.

17. Shaving apparatus as claimed in claim 14, wherein at least two cutting units (53) are provided, each having a perforated foil (55) extending at least partly over at least one intermediate skin contact surface (54) between two adjacent cutting units, wherein said intermediate skin contact surface is provided with shaving aid retaining means.

18. Shaving apparatus as claimed in claim 17, wherein the foils of two adjacent cutting units (53) extend over an intermediate skin contact surface (54) forming a strip-shaped area between their adjacent edges, and wherein shaving aid retaining means are provided at said strip-shaped area.

19. Shaving apparatus as claimed in anyone of the claims 14 to 18, wherein said shaving aid retaining means comprise a number of ridges and/or grooves or a pattern of dimples extending substantially parallel to the elongate cutting units.

20. Foil-shaped external cutting member (55) for at least one cutting unit (53) of a shaving apparatus as claimed in claim 17 or 18, said foil having at least one intermediate skin contact surface (54) between two cutting member sections (53), said intermediate surface (54) being provided with shaving aid retaining means.

21. Frame (57) for a shaving apparatus as claimed in claim 16, said frame having a recess (58) for at least one elongate cutting unit (53) and further having frame sections (59,60) extending along said at least one cutting unit, said frame sections at least partly forming skin contact surfaces provided with shaving aid retaining means.

22. Shaving apparatus as claimed in any one of the claims 14 to 19 or foil-shaped cutting member as claimed in claim 20 or frame as claimed in claim 21, wherein said shaving aid retaining means comprise elongate ridges and/or grooves, or a pattern of dimples.
